(19) United States
(12) Patent Application Publication
(10) Pub. No.: US 2026/0117518 A1
(43) Pub. Date: Apr. 30, 2026

(54) CARBON FIBER CLIP ANGLE

(71) Applicant: Eric Emmett Davis, Oak Park, IL (US)

(72) Inventor: Eric Emmett Davis, Oak Park, IL (US)

(21) Appl. No.: 18/933,737

(22) Filed: Oct. 31, 2024

(51) Int. Cl. E04B 2/96; F16M 13/02

(52) U.S. Cl. CPC E04B 2/965; F16M 13/02

(57) ABSTRACT

A clip angle bracket with reduced thermal conductance saves energy when used in structures such as a curtain wall assembly. The clip angle bracket includes a first curtain wall having a substantially flat surface. A second curtain wall has a substantially flat surface and is arranged at an angle relative to the first curtain wall. A hinge portion has a first end connected to the first curtain wall and a second end connected to the second curtain wall. The clip angle bracket is constructed of a carbon-reinforced fiber polymer (CRFP).

Applicant claims priority from U.S. provisional application 63/629,868 filed Dec. 11, 2023, the contents of which are hereby incorporated by reference in its entirety.

### BACKGROUND

### Technical Field

The present disclosure generally relates to building materials. More particularly, the present disclosure is generally related to a clip angle component (e.g., clip angle bracket) used in the construction of a building's non-structural exterior enclosure “curtain wall”.

### Description of the Related Art

Structures such as “curtain walls” are a building's non-structural exterior enclosure system connected to its superstructure, most commonly to the edge of a reinforced concrete floor or roof slab, or a structural edge beam. Curtain walls provide protection from the outside elements (e.g., wind, water). However, curtain wall systems do not provide support for the roof. Curtain wall framing members are non-load bearing (other than their own weight and a gravity of load of glass panes, etc.) and are often used in multi-story structures. The clip angle bracket is the element that is used to connect the curtain wall frame to the superstructure.

Clip angle brackets are conventionally constructed of metal. A side effect of their construction is thermal transference between the interior of the structure and the ambient temperature outdoors. As a result, some of the energy used to heat or to cool the interior of the structure is wasted by the thermal transference to the exterior of the structure.

### SUMMARY

In one embodiment, a clip angle bracket includes a first leg that has a substantially flat surface. A second leg has a substantially flat surface and is arranged at an angle relative to the first leg. A hinge has a first end connected to the first leg and a second end connected to the second leg. The clip angle bracket that is the subject of this disclosure is constructed of carbon-reinforced fiber polymer (CRFP), commonly referred to as “carbon fiber.”

In an embodiment that may be combined with the preceding embodiment, the angle at which the second leg is arranged relative to the first leg is substantially orthogonal.

In an embodiment that may be combined with one or more of the preceding embodiments, each of the first leg and the second leg has one or more openings sized to receive a fastener.

In an embodiment that may be combined with one or more of the preceding embodiments, the one or more openings in the first leg and the second leg are slots.

In an embodiment that may be combined with one or more of the preceding embodiments, the one or more slots are vertically and/or horizontally arranged in the first leg and the second leg.

In an embodiment that may be combined with one or more of the preceding embodiments, the first leg and the second leg are arranged in an L-shape.

In an embodiment, a curtain wall assembly includes one or more mullions. One or more carbon-reinforced fiber polymer (CRFP) clip angle brackets have a rate of thermal conduction less than a metal. The CRFP clip angle brackets include a first leg having a substantially flat surface, a second leg having a substantially flat surface and arranged at an angle relative to the first leg; and a hinge portion having a first end connected to the first leg and a second end connected to the second leg. The first leg and the second leg of the CRFP clip angle brackets is attached to one of the mullions by a fastener.

In an embodiment, a kit for a curtain wall assembly includes one or more mullions, and one or more carbon-reinforced fiber polymer (CRFP) clip angle brackets having a reduced rate of thermal conduction compared to conventionally used material such as metal. The CRFP clip angle brackets include a first leg having a substantially flat surface, and a second leg having a substantially flat surface and arranged at an angle relative to the first leg. A hinge portion has a first end connected to the first leg and a second end connected to the second leg. At least one of the first leg and the second leg of the CRFP clip angle brackets is configured for attachment to the one or more mullions by a fastener. The fastener(s) are optionally included in the kit.

### BRIEF DESCRIPTION OF THE DRAWINGS

The drawings presented herein show illustrative embodiments of the disclosure. They do not illustrate all embodiments. Other embodiments may be used in addition to or instead of the illustrative embodiments. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps. The drawings are not intended to depict every feature of every implementation nor relative dimensions of the depicted elements, and are not drawn to scale.

FIG. 1A is an illustration of a conventional aluminum clip angle bracket attached to a sleeve mullion.

FIG. 1B is an illustration of a conventional aluminum clip angle bracket attached to a continuous mullion.

FIG. 2 illustrates a CRFP clip angle bracket, consistent with an illustrative embodiment.

FIG. 3 is another illustration of a CRFP clip angle bracket, consistent with an illustrative embodiment.

FIG. 4 is an illustration of a CRFP clip angle bracket attached to a slab and to a different type of mullion, consistent with an illustrative embodiment.

### DETAILED DESCRIPTION

In the following description, numerous specific details are set forth to clearly describe various specific embodiments disclosed herein. One skilled in the art, however, will understand that the subject matter of the present disclosure may be practiced without all of the specific details discussed below. In other instances, well-known features may not have been described so as not to obscure the invention with unnecessary detail regarding known features.

As used herein, the term “and/or” is to be interpreted broadly is to be understood to refer to all or some of the elements. For example, “at least one of (a) and/or (b) means the teaching pertains only to element (a), or only to element (b), or to both element (a) and element (b). In another example, “at least one of (a), (b), and/or (c), means the teaching pertains to only element (a), or only to element (b), or only element (c), or to elements (a) and (b), elements (a) and (c), elements (b) and (c), or to all of (a), (b) and (c).

According to the present disclosure, there is a carbon fiber reinforced polymer (CFRP) clip angle bracket, commonly referred to as “carbon fiber” as a “clip angle” component of a building's non-structural exterior enclosure “curtain wall” or similar exterior enclosure systems.

Conventional clip angles are metal, such as aluminum or steel. However, CFRP clip angle brackets have a much higher strength-to-weight than the conventional aluminum or steel that the CRFP replaces. In addition, the CFRP clip angle bracket may have an elastic modulus per density of approximately 275 msi in³/lb, compared to approximately 100 msi in³/lb for 6000 series aluminum or low carbon steel.

There are tremendous environmental advantages in the use of a carbon fiber clip angle according to the present disclosure, in lieu of aluminum or steel. For example, the CRFP clip angle provides a substantial, or near-total, reduction in the conduction of heat from the structure or other interior elements to the exterior framing system. While CFRP has many different formulations, a manufacturer of the material notes that one of the more common formulations (with epoxy resin) has a heat conductivity in the range of 5 to 7 W/m², as compared to 50 W/m² for steel and 210 W/m² for aluminum.

Accordingly, the use of carbon fiber clip angles instead of metal nearly eliminates the “thermal shorts” that metal clip angles typically introduce into a building exterior. These thermal shorts are locations where the insulation value of the rest of the exterior envelope system is compromised, allowing heat from the interior to be lost to the exterior, undermining the overall thermal or insulative value of the curtain leg system. In addition, metal clip angles, because they conduct and lose heat so readily, cause condensation, which causes corrosion. Aluminum was introduced as a replacement for steel clip angles because steel clip angles tend to corrode faster. Although aluminum corrodes much more slowly, aluminum is not as strong as steel and has even worse thermal properties. The use of carbon fiber eliminates the condensation/corrosion concern as well.

### Example Embodiment(s)

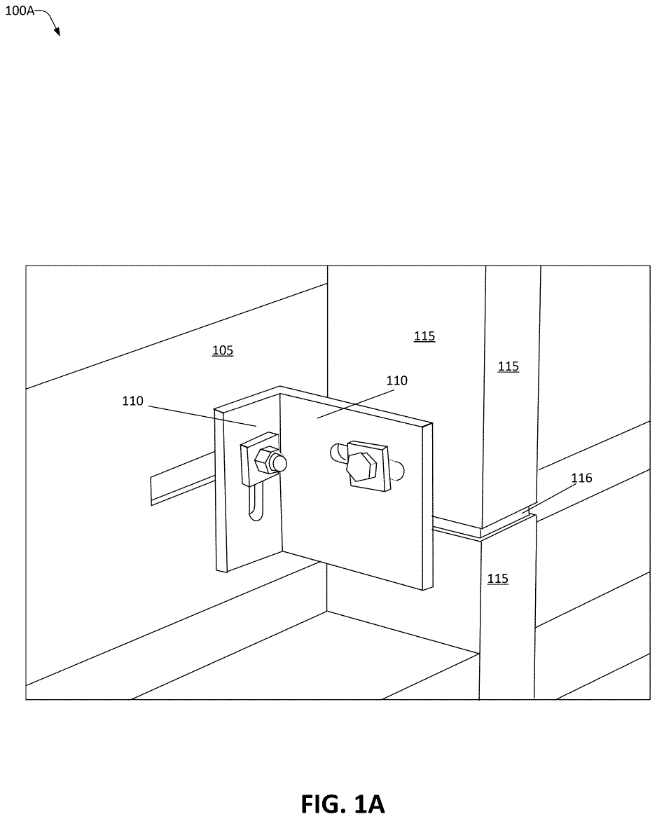

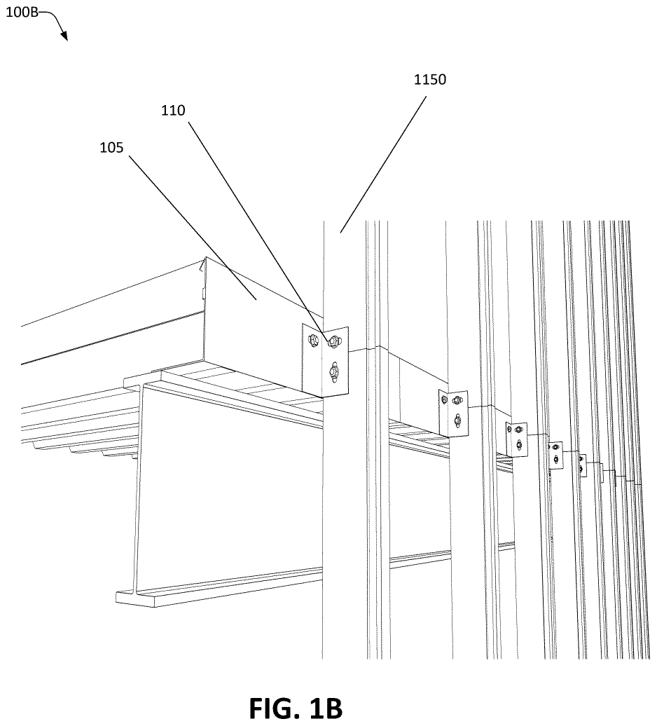

FIGS. 1A and 1B are illustrations (100A, 100B) of a conventional aluminum clip angle bracket. Referring to FIG. 1A, the aluminum clip angle bracket 110 is shown attaching a mullion 115 to a slab 105 (typically made of concrete). The aluminum clip angle bracket 110 causes a loss of interior heat or cooling that has occurred in a structure because the thermal conductivity of the aluminum is high. Thus, energy and expenses are wasted to heat or cool the structure because of the inefficiency of the aluminum clip angle bracket(s) 110. Typically, a curtain wall will have multiple mullions 115 and multiple clip angle brackets 110, and often more than one clip angle bracket 110 per mullion 115. Thus, the aggregate loss of interior heat or cooling is significant because of the clip angle brackets 110.

With continued reference to FIGS. 1A and 1B, the mullion 115 shown in FIG. 1A is known in the art as a sleeve mullion because there is a sleeve 116 connection to permit vertical movement (expansion and contraction) between the mullion(s) 115. However, a continuous mullion 1150, as shown in FIG. 1B, may also be used. In either case, the loss of heat or cooling caused by the aluminum clip angle bracket 110 wastes energy and money.

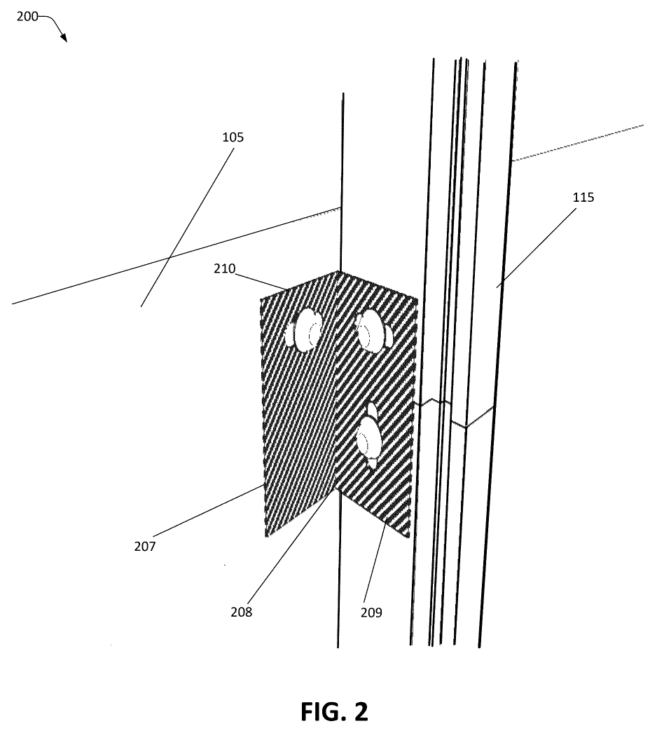

FIG. 2 is an illustration 200 of a CRFP clip angle bracket 205, consistent with an illustrative embodiment. The CFRP clip angle bracket 205 is connected between the slab 105 and the mullion 115 similar to as shown in FIG. 1A. The CRFP clip angle bracket has two legs 207, 209, and a hinge portion 208. In this embodiment, the legs 207, 209 and the hinge portion 208 are all made of CRFP. The sizes of the legs 207, 209 of the clip angle bracket 210 will vary for the geometries of the specific project application and the calculated loads. The locations, directions, and dimensions of bolting slots can be shop fabricated or, because of the nature of the CFRP material, may be field cut. It is also the nature of the material, applied in this way, that nearly eliminates the “thermal shorts” or conduction of heat from the interior structure to the exterior envelope, which occurs with the aluminum example illustrated in FIGS. 1A and 1B.

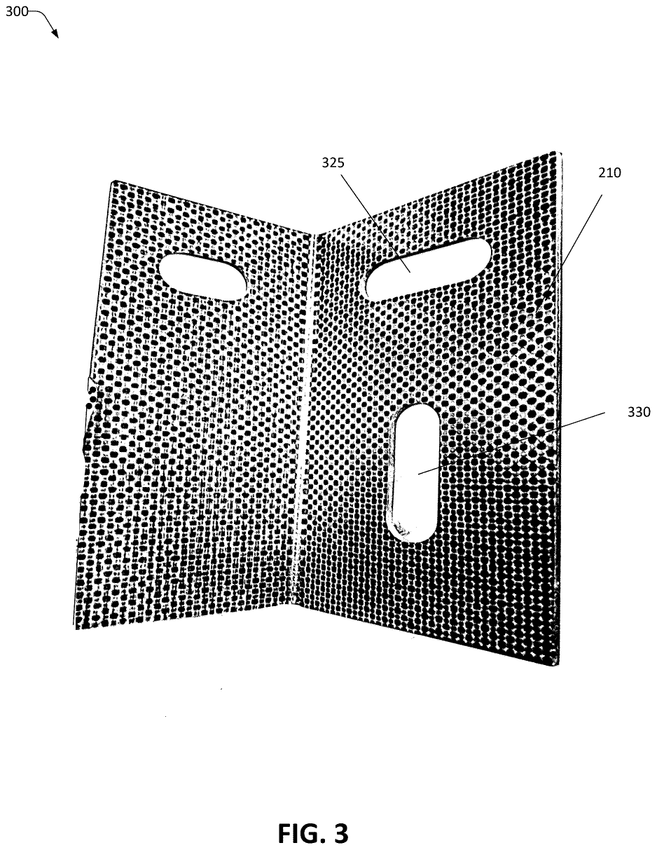

FIG. 3 is another illustration 300 of a CRFP clip angle bracket, consistent with an illustrative embodiment. Here it can be seen that the clip angle bracket 210 has openings such as horizontal slots 325 and vertical slots 330 arranged to facilitate fasteners (shown in FIG. 2) to attach the clip angle brackets to the slab 105 and the mullions 115. While the opening are shown as slots 325, 330, it is to be understood that the openings may be virtually any shape (e.g. square, circular, irregular, hexagonal), and these openings may be made at the point of manufacture or in the field during installation.

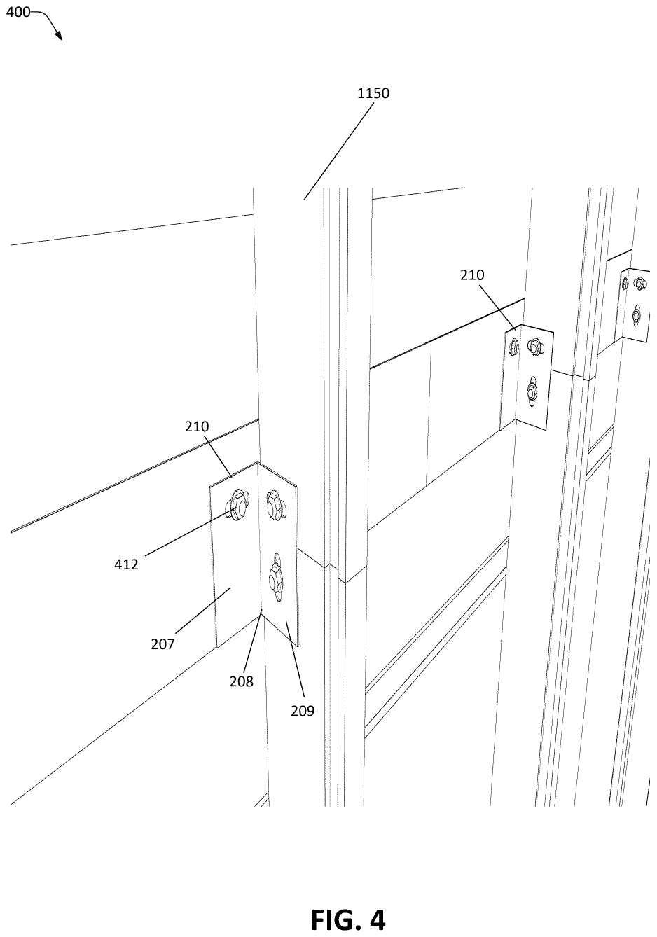

FIG. 4 is an illustration 400 of a plurality of CRFP clip angle brackets attached to a slab, consistent with an illustrative embodiment. While the mullions shown continuous mullions 1150, sleeve mullions (such as shown in FIG. 1A) may also be used. The CFRP clip angle bracket 210 is similar to the CRFP clip angle brackets previously shown and described in FIGS. 2 and 3. The use of the CFRP clip angle brackets 210 as shown result in a significant savings in energy and costs. Although the fasteners 412 shown are nuts and bolts, other types of fasteners, and washers, may be used.

While several illustrative embodiments of the present disclosure have been shown and described, numerous variations and alternative embodiments will occur to those skilled in the art. Such variations and alternative embodiments are contemplated, and can be made without departing from the scope of the disclosure as defined in the appended claims. For example, while a curtain wall has been described for use of the CFRP clip angle bracket, similar wall structures will benefit from the use of the CFRP clip angle.

As used in this specification and the appended claims, the terms “coupled” and “connected to” may have intervening elements arranged between a first element and a second element.

As used in this specification and the appended claims, the singular forms “a,’ ‘an, ” and “the” include plural referents unless the content clearly dictates otherwise. The term plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, paragraph (f), unless the element is expressly recited using the phrase “means for. and no method or process step herein is to be construed under those provisions unless the step, or steps, are expressly recited using the phrase” step(s) for . . . ”

What is claimed is:

1. A clip angle bracket with reduced thermal conductance, comprising:
a first leg having a substantially flat surface;
a second leg having a substantially flat surface and arranged at an angle relative to the first leg; and
a hinge portion having a first end connected to the first leg and a second end connected to the second leg;
wherein the clip angle bracket is constructed of a carbon-reinforced fiber polymer (CRFP).

2. The clip angle bracket according to claim 1, wherein the angle at which the second leg is arranged relative to the first leg is substantially orthogonal.

3. The clip angle bracket according to claim 1, wherein each of the first leg and the second leg has one or more openings sized to receive a fastener for attachment to a slab or a mullion.

4. The clip angle bracket according to claim 3, wherein the one or more openings in the first leg and the second leg are slots.

5. The clip angle bracket according to claim 4, wherein the one or more slots are vertically and/or horizontally arranged in the first leg and the second leg.

6. The clip angle bracket according to claim 1, wherein the first leg and the second leg are arranged in an L-shape.

7. The clip angle bracket according to claim 1, wherein the first leg and the second leg are arranged in a V-shape.

8. The clip angle bracket according to claim 1, wherein the clip angle bracket has a has a heat conductivity ranging from about 5 to 7 W/m².

9. A curtain wall assembly comprising:
one or more mullions;
one or more carbon-reinforced fiber polymer (CRFP) clip angle brackets having a rate of thermal conduction less than a metal;
wherein the CRFP clip angle brackets comprise:
a first leg having a substantially flat surface;
a second leg having a substantially flat surface and arranged at an angle relative to the first leg; and
a hinge portion having a first end connected to the first leg and a second end connected to the second leg; and
where one of the first leg and the second leg of the CRFP clip angle brackets is attached to the one of the mullions by a fastener.

10. The curtain wall assembly according to claim 9, wherein the CFRP clip angle bracket has a heat conductivity ranging from about 5 to 7 W/m².

11. The curtain wall assembly according to claim 9, wherein the angle at which the second leg is arranged relative to the first leg is substantially orthogonal.

12. The curtain wall assembly according to claim 11, wherein each of the first leg and the second leg has one or more openings sized to receive a fastener for attachment to a slab or a mullion.

13. The curtain wall assembly according to claim 12, wherein the one or more openings in the first leg and the second leg are slots.

14. The curtain wall assembly according to claim 13, wherein the one or more slots are vertically and/or horizontally arranged in the first leg and the second leg.

15. The curtain wall assembly according to claim 9, wherein the first leg and the second leg are arranged in an L-shape.

16. The curtain wall assembly according to claim 9, wherein the first leg and the second leg are arranged in a V-shape.

17. A kit for a curtain wall assembly, the kit comprising:
one or more mullions;
one or more carbon-reinforced fiber polymer (CRFP) clip angle brackets having a rate of thermal conduction less than a metal;
wherein the CRFP clip angle brackets comprise:
a first leg having a substantially flat surface;
a second leg having a substantially flat surface and arranged at an angle relative to the first leg; and
a hinge portion having a first end connected to the first leg and a second end connected to the second leg; and
where one of the first leg and the second leg of the CRFP clip angle brackets is attached to the one or more mullions by a fastener.

18. The kit according to claim 17, wherein at least one of the one or more mullions comprises a sleeve-mullion.

19. The kit according to claim 17, wherein at least one of the one or more mullions comprises a continuous-mullion.

20. The kit according to claim 17, wherein the CFRP clip angle bracket has a heat conductivity ranging from about 5 to 7 W/m².
